(19) United States
(12) Patent Application Publication
(10) Pub. No.: US 2007/0068784 A1
(43) Pub. Date: Mar. 29, 2007

(54) Backlit keyboard

(76) Inventor: Charles A. Sellers, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/238,459

(22) Filed: Sep. 29, 2005

(51) Int. Cl. H01H 9/00

(52) U.S. Cl. 200/314

(57) ABSTRACT

A computer device comprising a keyboard having a lightpipe base plate configured to direct light received from a light source toward at least one keycap of the keyboard.

### BACKGROUND OF THE INVENTION

Computer devices, such as notebook or laptop computers, are increasingly being used in places such as automobiles, planes, classrooms, and outside. However, the surrounding environment is not always a suitable working environment for the computer device, and insufficient lighting conditions further detract from a user's ability to adequately utilize the computer device. To overcome such insufficient lighting conditions, light sources have been incorporated into the computer device to direct light downward onto the top of a keyboard of the computer device to facilitate use of the keyboard in low-light conditions. Further, electrical luminance (EL) elements have been used to direct light upwardly from below the keycaps of the keyboard to illuminate the keyboard in low-light conditions. However, such solutions are costly, have a relatively short life, have high power consumption and increase the thickness and cost of the keyboard and/or computer device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a computer device in which an embodiment of a backlit keyboard in accordance with the present invention is used to advantage; and

FIG. 2 is a diagram illustrating a sectional view of the backlit keyboard of FIG. 1.

### DETAILED DESCRIPTION OF THE DRAWINGS

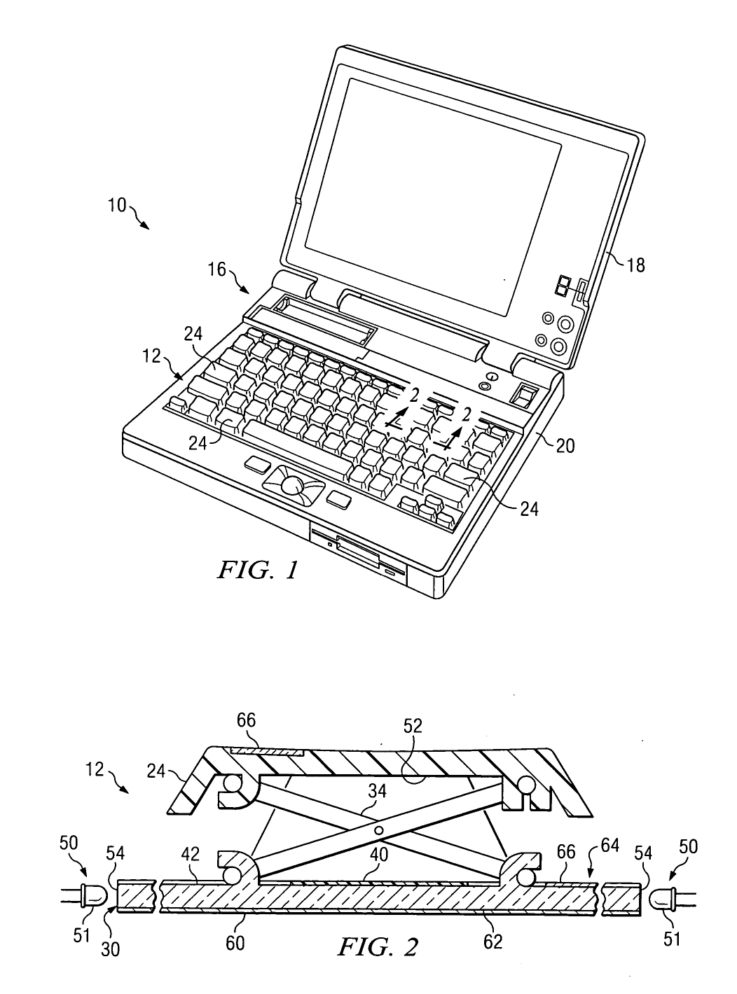

The preferred embodiments of the present invention and the advantages thereof are best understood by referring to FIGS. 1 and 2 of the drawings, like numerals being used for like and corresponding parts of the various drawings.

FIG. 1 is a diagram illustrating a computer device 10 in which an embodiment of a backlit keyboard 12 in accordance with the present invention is used to advantage. In the embodiment illustrated in FIG. 1, computer device 10 comprises a portable laptop or notebook computer 16 having a display member 18 rotatably coupled to a base member 20. However, it should be understood that computer device 10 may comprise other types of devices such as, but not limited to, a tablet computer, personal digital assistant, handheld gaming device or other type of portable or non-portable computer device. Further, in the embodiment illustrated in FIG. 1, keyboard 12 is integrated into computer device 10. However, it should be understood that backlit keyboard 12 may be configured as a separate and/or discrete component (e.g., a stand-alone keyboard 12 communicating via a wired or wireless connection to another computer device such as a desktop computer).

FIG. 2 is a diagram illustrating a section view of an embodiment of keyboard 12 of FIG. 1 taken along the line 2-2 of FIG. 1. In the embodiment illustrated in FIG. 2, keyboard 12 comprises keycaps 24 for receiving user input therewith and a lightpipe base plate 30 for providing backlighting to keycap(s) 24. For example, preferably, lightpipe base plate 30 is manufactured and/or otherwise formed from glass, plastic or another suitable optically transmissive material to facilitate light transfer therethrough. The embodiment illustrated in FIG. 2 shows keycap(s) 24 moveably coupled to lightpipe base plate 30 by a plunger or scissor mechanism 34 and a spring mechanism 36 (e.g., a rubber dome or other flexibly resilient material) to bias keycap(s) 24 away from lightpipe base plate 30 while facilitating depression of keycap(s) 24 toward lightpipe base plate 30 such that spring mechanism 36 contacts and/or otherwise engages a circuit pad 40 to register actuation of a particular keycap 24. However, it should be understood that other methods and/or devices may be used to facilitate movement and/or actuation of keycap(s) 24 for receiving user input thereof. In the embodiment illustrated in FIG. 2, circuit pad 40 is disposed on a side 42 of lightpipe base plate 30 to facilitate engagement therewith by keycap(s) 24.

In the embodiments illustrated in FIG. 2, at least one light source 50 is disposed at a peripheral location of lightpipe base plate 30 for providing light to lightpipe base plate 30 to facilitate transfer of such light by lightpipe base plate 30 toward an underside 52 of keycap(s) 24. For example, in the embodiments illustrated in FIG. 2, light source 50 comprises at least one light emitting diode (LED) 51 disposed at and/or near an edge 54 of lightpipe base plate 30 for directing light toward and/or into lightpipe base plate 30. However, it should be understood that other types of light sources may be used and/or otherwise located relative to lightpipe base plate 30. Preferably, in some embodiments of the present invention, a plurality of light sources 50 are disposed about a periphery of lightpipe base plate 30 to facilitate uniform light distribution and/or dispersal through lightpipe base plate 30 and upwardly toward keycap(s) 24. However, it should be understood that the position and or placement of light source(s) 50 relative to lightpipe base plate 30 may be otherwise configured.

In the embodiment illustrated in FIG. 2, keyboard 12 comprises a reflective layer 60 disposed on a side 62 of lightpipe base plate 30 opposite side 42 of lightpipe base plate 30 to facilitate reflection of light upwardly toward keycap(s) 24. For example, in some embodiments of the present invention, reflective layer 60 comprises a reflective substance applied and/or otherwise coated to side 62 of lightpipe base plate 30. However, it should be understood that reflective layer 60 may be otherwise configured and/or manufactured. For example, in some embodiments of the present invention, reflective layer 60 comprises a separate and/or discrete layer of reflective material disposed between side 62 of lightpipe base plate 30 and a portion of, for example, a housing of base member 20 (FIG. 1) (e.g., laying between side 62 and a housing of base member 20 in contact with or spaced apart from side 62). In yet other embodiments of the present invention, reflective layer 60 comprises a separate and/or discrete layer of reflective material adhesively and/or otherwise bonded to side 62 of lightpipe base plate 30.

Thus, in operation, light source(s) 50 emit light toward and/or into lightpipe base plate 30. Lightpipe base plate 30 receives the light from light source(s) 50 and transmits and/or otherwise directs the light upwardly toward underside 52 of keycap(s) 24. In the embodiment illustrated in FIG. 2, keycap(s) 24 are configured having a translucent and/or otherwise light-transmissive portion 66 corresponding to a character designation and/or key recognition element such that light received from lightpipe base plate 30 illuminates such portion 66. However, it should be understood that keycap(s) 24 may be otherwise configured. For example, in some embodiments of the present invention, keycap(s) 24 are configured to be entirely light-transmissive (or substantially light-transmissive) having a character designation and/or key recognition element screened onto an upper surface thereof. Reflective layer 60 reflects light in lightpipe base plate 30 upward toward and out of side 42 of lightpipe base plate 30, thereby facilitating backlighting of keycap(s) 24 and preventing (or substantially preventing) light from being emitted downwardly or through side 62 of lightpipe base plate 30 away from keycap(s) 24. It should be understood that activation/deactivation of light source(s) 50 may be automatic (e.g., responsive to ambient light conditions relative to keyboard 12 and/or computer device 10) and/or user responsive (e.g., activated/deactivated in response to a user request using a keystroke function, selectable icon and/or otherwise).

Preferably, lightpipe base plate 30 is configured to facilitate backlighting across the entire width/length and/or profile of lightpipe base plate 30. However, it should be understood that lightpipe base plate 30 may be otherwise configured to provide, for example, particular areas of backlighting and/or varied levels of backlight illumination. For example, in some embodiments of the present invention, one or more portions 64 of side 42 of lightpipe base plate 30 may be coated with an optically translucent and/or non-transmissive material 66 to diminish and/or block light from being directed upwardly and/or out of lightpipe base plate 30 at such locations, thereby enabling various different backlit configurations and/or characteristics of keyboard 12.

Thus, embodiments of the present invention provide a backlit keyboard 12 that is lightweight, generally low cost (e.g., few components), and generally thin (e.g., occupying less dimensional space within computer device 10). Further, embodiments of the present invention are configurable to provide desired levels and/or patterns of backlighting to keyboard 12.

1. A computer device, comprising:
a keyboard having a lightpipe base plate configured to direct light received from a light source toward at least one keycap of the keyboard.

2. The device of claim 1, wherein the at least one keycap is coupled to the lightpipe base plate.

3. The device of claim 1, further comprising a scissor mechanism movably coupling the at least one keycap to the lightpipe base plate.

4. The device of claim 1, wherein the light source comprises at least one light emitting diode (LED).

5. The device of claim 1, wherein the at least one light source comprises a plurality of light sources disposed about a periphery of the lightpipe base plate.

6. The device of claim 1, further comprising a reflective layer disposed on a side of the lightpipe base plate opposite a side of the at least one keycap.

7. The device of claim 1, further comprising a reflective layer disposed on the lightpipe base plate and configured to reflect the light received from the at least one light source toward the at least one keycap.

8. The device of claim 1, wherein the lightpipe base plate is configured to direct the light received from the light source toward an underside of the at least one keycap.

9. The device of claim 1, wherein the at least one light source is disposed at an edge of the lightpipe base plate.

10. The device of claim 1, wherein at least a portion of a side of the lightpipe base plate facing toward the at least one keycap is configured to be light non-transnissive.

11-19. (canceled)

20. A backlit keyboard, comprising:
at least one keycap;
at least one light source; and
a lightpipe base plate configured to direct light received from the at least one light source toward the at least one keycap.

21. The keyboard of claim 20, wherein the at least one keycap is coupled to the lightpipe base plate.

22. The keyboard of claim 20, further comprising a scissor mechanism movably coupling the at least one keycap to the lightpipe base plate.

23. The keyboard of claim 20, wherein the at least one light source comprises at least one light emitting diode (LED).

24. The keyboard of claim 20, further comprising a plurality of light sources disposed about a periphery of the lightpipe base plate.

25. The keyboard of claim 20, further comprising a reflective layer disposed on a side of the lightpipe base plate opposite a side of the at least one keycap.

26. The keyboard of claim 20, further comprising a reflective layer disposed on the lightpipe base plate and configured to reflect the light received from the at least one light source toward the at least one keycap.

27. The keyboard of claim 20, wherein the lightpipe base plate is configured to direct the light received from the light source toward an underside of the at least one keycap.

28. The keyboard of claim 20, wherein the at least one light source is disposed at an edge of the lightpipe base plate.

29. The keyboard of claim 20, further comprising a circuit pad coupled to at least a portion of the lightpipe base plate facing the at least one keycap.

30. The keyboard of claim 20, wherein at least a portion of a side of the lightpipe base plate facing toward the at least one keycap is configured to be light non-transmissive.
